(19) United States
(12) Patent Application Publication
(10) Pub. No.: US 2013/0317951 A1
(43) Pub. Date: Nov. 28, 2013

(54) AUTO-ANNOTATION OF VIDEO CONTENT FOR SCROLLING DISPLAY

(71) Applicant: Vsevolod Kuznetsov, Sankt-Petersburg (RU)

(72) Inventor: Vsevolod Kuznetsov, Sankt-Petersburg (RU)

(73) Assignee: RAWLLIN INTERNATIONAL INC.

(21) Appl. No.: 13/480,954

(22) Filed: May 25, 2012

(51) Int. Cl. G06F 3/14; G06Q 30/06

(52) U.S. Cl. 705/27.1; 715/719

(57) ABSTRACT

Generally described is auto annotation of video content for scrolling display. A network service can receive video content. The content can be automatically annotated to generate differing sets of the content. The varying sets of content can be scrolled in a content browser. In response to receiving a selection, from the content browser, of a set of video content among the scrolling sets of video content, the selection can be displayed while the scrolling continues during the display.

### TECHNICAL FIELD

This application relates to content management, e.g., automatic annotation of video content for scrolling and display.

### BACKGROUND

The proliferation of Internet hosted video content has been a boon to businesses and consumers alike. Internet hosted video content can include a brief video of just a couple seconds, a short video such as a news story, a full featured film running several hours long, or even a day long seminar. Along with the growth in available video content, there has been a similar growth in the types of devices that can be used to access that video content. Computers, tablets, e-readers, and smart phones are just some of the categories of devices available to consumers and businesses to access content.

The varying types of video content, and the varying types of devices that can access that content, can present challenges in packaging the content to meet consumer and business desires. For example, for a user viewing a collection of news stories, some users may want to watch all the news stories, in their entirety, in a certain order. Other users may wish only to view a brief summary of each story, and select which stories they want to view in more depth. Still other users may only want to be exposed to random slices of various news stories.

For businesses that sell internet hosted video content, exposing potential customers to the hosted video content the business wants them to purchase, in a preview, can help generate purchases. One example of such previews are movie trailers, which highlight scenes, actors, plot lines, etc. of a movie, to garner interest in the movie, without having to show large parts of the movie. Movie studios often create several trailers relating to a single movie, such as a short trailer, long trailer, teaser trailer, etc. Trailers can be designed to appeal to certain demographics, or certain types of consumers to make them more effective.

While the original author or creator of the video content can create differing versions of the video content, like movie trailers, this relies on all authors to be good Samaritans to be useful on a grander scale. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to automatic annotation of content. An input component can receive video content. An auto abstract component can generate sets of abstracts of the video content in response to reception of the video content. An output component can send a first set of the sets of the abstracts to a content browser.

In another embodiment, video content can be received. In response to receiving the video content, differing sets of the video content can be generated wherein the sets of the video content are associated with respective levels of detail applicable to the video content. The set of the video content can be scrolled on a content browser. A selection can be received, from the content browser, of a set of video content from the scrolling sets of the video content.

It yet another embodiment, in response to receiving video content, differing sets of the video content can be generated, wherein a set of the sets of the video content is associated with a level of detail different from another level of detail associated with at least one other set of the sets of the video content. A first input can be received that scrolls the sets of the video content on a content browser. A second input can be receiving that selects the set of the video content among the scrolled sets of the video content. In response to receiving the second input, the set of video content can be displayed without interruption of the scrolling.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example content browser using scrolling to display sets of video content;

FIG. 2 illustrates an example content browser using scrolling to display abstracts of video content including a timer;

FIG. 3 illustrates an example flow diagram method for auto annotation of video content for scrolling;

FIG. 4 illustrates an example flow diagram method for auto annotation of video content for display and scrolling based on a selection;

FIG. 5 illustrates an example flow diagram method for auto annotation of video content for labeling, display and scrolling;

FIG. 6 illustrates an example flow diagram method for auto annotation of video content for display and scrolling associated with news stories;

FIG. 7 illustrates an example network service;

FIG. 8 illustrates an example network service including an abstract switching component;

FIG. 9 illustrates an example network service including a timing component;

FIG. 10 illustrates an example network service including an access component;

FIG. 11 illustrates an example block diagram of a computer operable to execute the disclosed architecture; and

FIG. 12 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods disclosed herein provide for auto annotation of video content. The system provides for automatically creating different levels of abstraction of content where it was not previously available or explicitly provided. Video content can be analyzed based on a combination of features to determine annotated sections of the video content. It can be appreciated that through auto annotation, shorter versions of video content like a news story, a movie, a seminar, etc. can relay key concepts or conclusions from the video content in a shorter format that is more desirable for a user to determine whether they are interested in viewing the entirety of the video content.

A user of a content browser may request to view video content. In an example, the user may request to view a set of news stories. The set of news stories can be received and in response to the receiving, differing sets of the video content can be generated and associated with a level of detail. For example, both audio and video features can be analyzed to aid in generated the differing sets of video content.

Video features such as a histogram of local features, a color histogram, edge features, a histogram of textons, face features, camera motion, or shot boundary features can be analyzed to determine natural breaks in video composition. For example, known facial recognition algorithms can be used to identify when certain individuals are present in the video. In the example of a news story, the portion of the video content where the news reader is talking in a studio can be separated from video content related to the news story itself, i.e. through facial recognition or other video features. When the video returns to the previously recognized studio, it may signal the start of a second story that can separated from the first story. Fades, wipes, or pauses can be identified where clear breaks between scenes are identified or where static video content does not change. These moments can be identified as transitions from one scene to another, or breaks between sections of video content, and can be annotated or removed from shorter versions of the content.

In addition to video features, audio features of the video content can be analyzed to aid in generating differing sets of video content. For example, speech recognition algorithms can be applied to audio of the video content. Specific speakers can be identified based on known speech recognition algorithms to identify individual speakers. In one example, an original video could be divided into differing sets of video based upon which individual was speaking at any one time in the video. Thus, a set of video content could be tailored to just one individual speaking in video content that contains multiple speakers. For example, a set of seminar videos can be analyzed to generate differing sets based on the speaker at any time during the seminar video. Thus, a user of a content browser could select to view only video related to a certain speaker rather than watching the entirety of every speaker at the seminar.

In one embodiment, speech content can be separated into a set of sentences, and the sentences into sets of words. Morphological features for each word can be identified, such as part of speech, a gender, a case, a number, a date, a proper noun, etc. Some words can be multiple types of part of speech. During morphological analysis, words with multiple possible “part of speech” delineations can be identified for further analysis during a parsing phase. It can be appreciated that during a morphological analysis, a word dictionary, a phrase dictionary, a person data store, a company data store, or a location data store can be used in determining morphological features associated with a word.

Parsing can define subgroups of related words in a sentence. For example, adjective-verb or noun-verb combinations can be identified. The establishment of these subgroups can help determine ambiguities in morphological analysis. Parsing can provide additional insights that morphological feature analysis did not provide, allowing for morphological features to be updated after the parsing stage with the additional information learned.

Semantic analysis can follow parsing, and can be based off updated morphological features associated with the sets of words and sets of sentences. Semantic analysis provides for construction grade wood ties of words within a sentence, identifying the words and/or phrases necessary for “meaning” In effect, semantic analysis is the extraction of meaning from the audio.

Using morphological analysis, parsing, and semantic analysis to extract meaning for speech of the video content can help identify key parts of the video content. For example, a pre-existing summary associated with the video content may be known. Using keywords from the summary, portions of the video content that most relate to the keywords from the summary can be identified and incorporated into an annotated section of the video content.

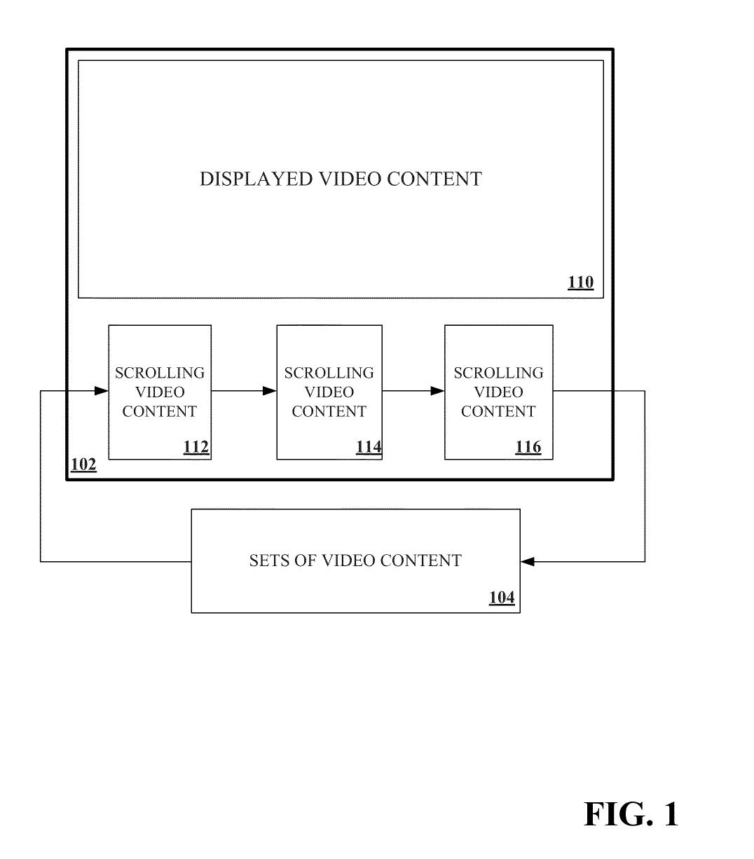

Referring now to FIG. 1, there is illustrated an example content browser using scrolling to display sets of video content. Screen 102 is an example screen layout of a content browser displaying video content in accordance with various embodiments. Screen 102 can show displayed video content 110. Screen 102 can also scroll scrolling video content 112, 114, 116, etc. It can be appreciated that video content among the sets of video content 104 can continuously scroll across screen 102.

Sets of video content 104 can include various levels of summaries based on analyzing video features and audio features of the audio content. For example, for a news story, varying length summaries can be present for each story, e.g., a 10 second summary, a 15 second summary, a 30 second summary, etc. Video content among the sets of video content 104 can be labeled based on the content. For example, displayed video content 110 may be a full version of a news story lasting 10 minutes long. Scrolling video content 112 may be a 20 second summary of the same content, scrolling video content 114 may be a 40 second summary of the same content, while scrolling video content 116 may be a minute summary of the same content. It can be appreciated that the number of scrolling video options is not limited by the three shown in FIG. 1 and can include more or less than three as scrollable options. A user of the content browser may wish to select a shorter version of the displayed video content 110, and upon selection, the shorter version will then be displayed in displayed video content box 110. It can further be appreciated that scrolling video content 112, 114, and 116 may or may not relate to displayed video content 110. Scrolling video content will continue to scroll during display of displayed video content 110.

In one embodiment, after displayed video content 110 is completed, the next scrolling video content in queue will begin playing automatically. In one embodiment, after selecting a scrolling video content to view, and viewing the scrolling video content, a user of the content browser is returned to the scrolling video content in the place where they left off.

Scrolling video content 112, 114, and 116 can include video previews whereby when a user of the content browser hovers a pointer over the scrolling video content, or a finger on a touch user interface, the scrolling video content may begin to play in preview. Related audio to the scrolling video content may or may not play during the hovering. In one embodiment, if displayed video content 110 is currently displaying a video, then related audio for a scrolling video content will not play when a pointer or finger is hovering over a scrolling video content option. In other embodiments, scrolling video content can be textual summaries and may not be capable of a video preview.

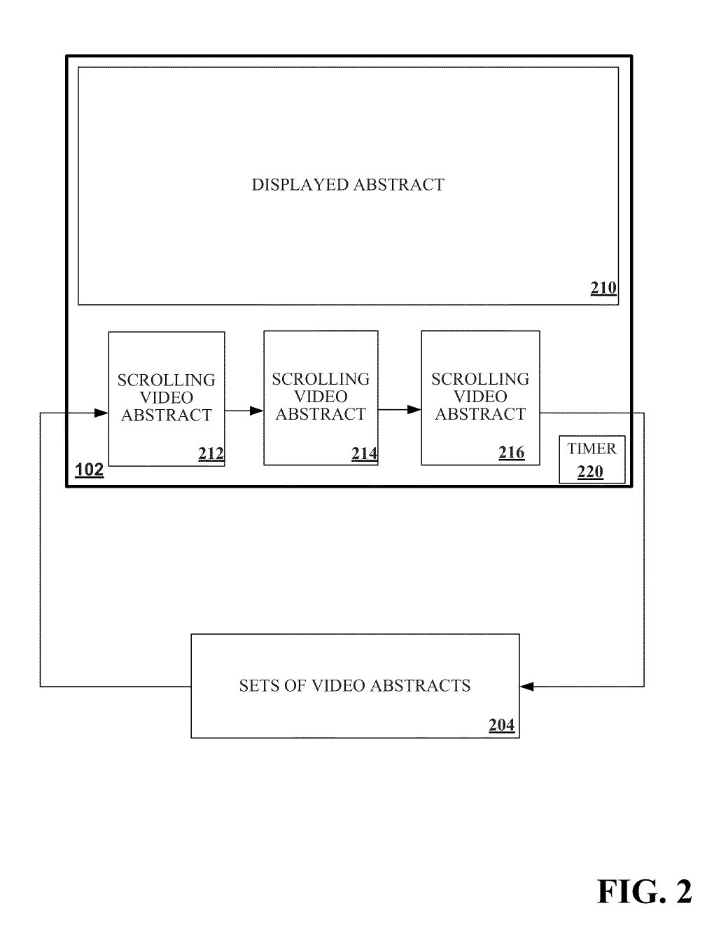

Referring now to FIG. 2, there is illustrated an example content browser using scrolling to display abstracts of video content including a timer. The set of abstracts 204 can be random points of video content, pre-defined chapters of content (e.g., seek points made by the author), key points of video content based on speech recognition analysis, key points of video content based on video analysis, etc. A timer 220 can aggregate the total amount of time spent watching video abstracts.

As an example, the interface in FIG.2 can be used to preview video content associated with a full length feature film. Rather than use trailers, random points of the video can be selected to scroll as scrolling video abstract 212, 214, 216, etc. A user can select various scrolling abstracts for display as a displayed abstract 210. Timer 220 can count the total time spent viewing any abstract as a displayed abstract 210. Users can be limited to a total amount of time spent watching abstracts of the video before being forced to purchase the full length feature film if they wish to keep watching. In this sense, a user may get a different exposure to a film besides watching a designed trailer, or in-lieu of a trailer for video content where a trailer is not available as a preview.

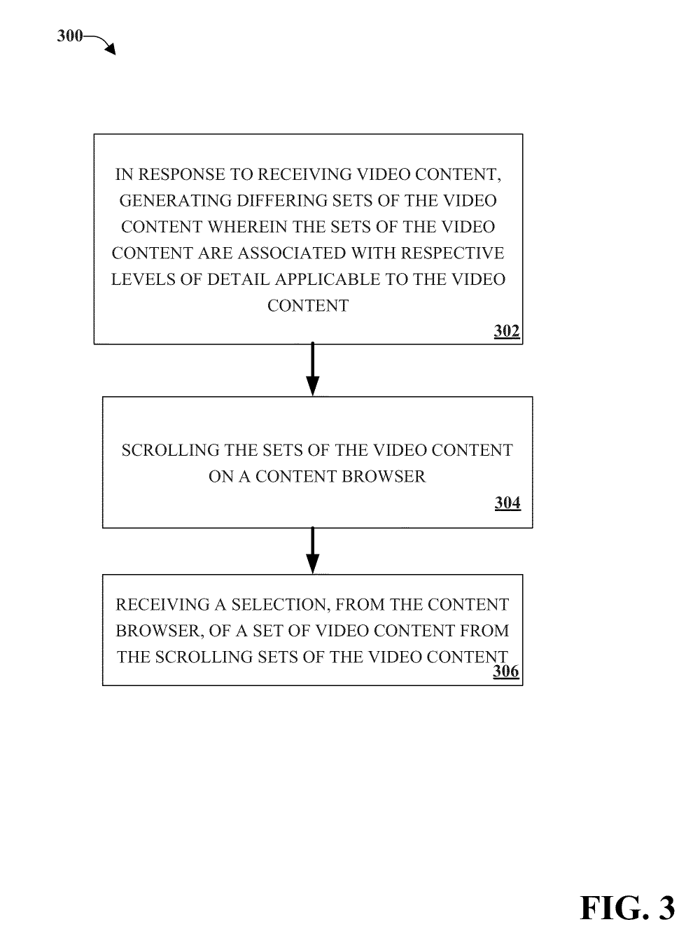

FIGS. 3-6 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 3, there is illustrated an example flow diagram method 300 for auto annotation of video content for scrolling. At 302, in response to receiving video content, generating, by at least one computing device including at least one processor, differing sets of the video content wherein the sets of the video content are associated with respective levels of detail applicable to the video content. Video content can include a single video, multiple related videos, multiple unrelated videos, etc. Video content is not limited to a certain file size or format. Differing sets of the video content can be both continuous video sequences from original video content, or cut out video segments repackaged in original or a different order. Differing sets of the video content can be generated based on both video and audio features related to the video content as described more fully with respect to FIGS. 1 and 2 respectively. In one example, video content received at 302 can be a set of news stories. Differing sets of the video content can include the first 15 seconds of each news story, the first 30 seconds of each news story, the full video segment for each news story, the first section of each news story in studio before video footage is shown outside the studio, segments of every news story related to an individual speaker, segments of video shot outside, segments with certain individuals on camera, etc. It can be appreciated that these examples work well outside a news story context as well. Level of detail can relate to individuals on video, individuals on audio, camera locations, video scenes, video chapters, random sections of video, a summary of content based on analysis of audio features and/or video features, etc.

At 304, the sets of the video content can be scrolled on a content browser. The scrolling can include a text list, an image preview, a video preview, an audio preview or a combination of multiple entries in the preceding list. Scrolling can be static that changes in response to user input, i.e., when a user scrolls through a list more options are presented. Scrolling can be automatic in that new entries to a list are added while other entries to the list are removed, without continuous additions and removals over time. Scrolling video content can be video content that is related or unrelated to other scrolling video content.

At 306, a selection can be received, from the content browser, of a set of video content among the scrolling sets of video content. For example, a user of a content browser can select one of the scrolling video content for display, for removal from the scrolling list, for later retrieval, etc.

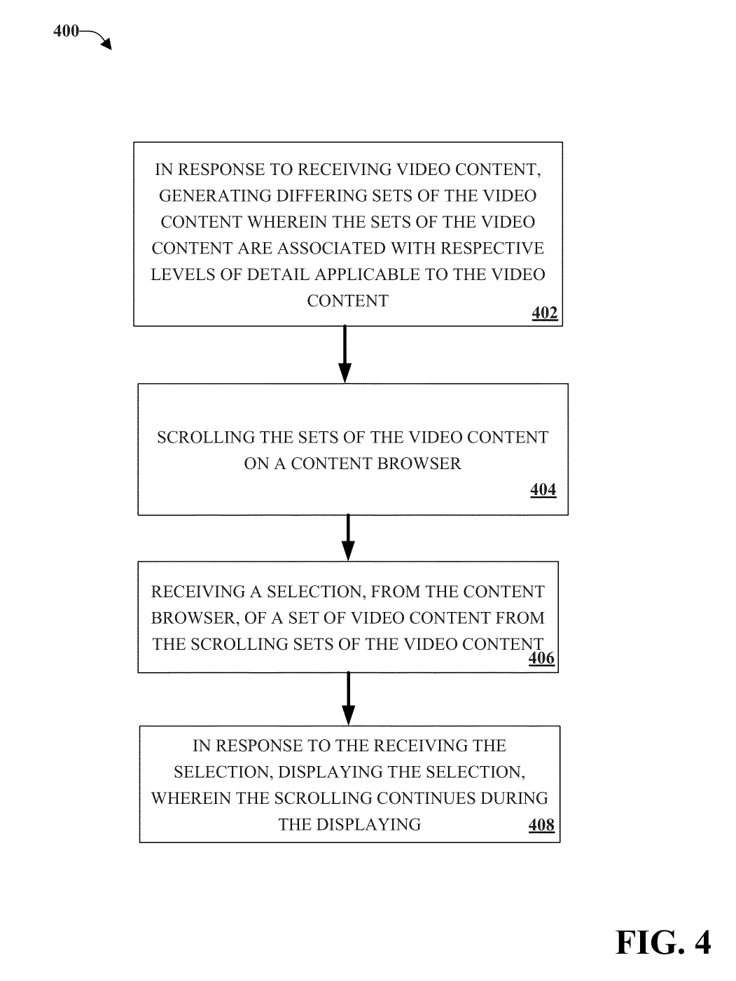

Referring now to FIG. 4, there is illustrated an example flow diagram method 400 for auto annotation of video content for display and scrolling based on a selection. At 402, in response to receiving video content, generating, by at least one computing device including at least one processor, differing sets of the video content wherein the sets of the video content are associated with respective levels of detail applicable to the video content. At 404, the sets of the video content can be scrolled on a content browser. At 406, a selection can be received, from the content browser, of a set of video content among the scrolling sets of video content.

At 408, in response to the selection, the selection can displayed wherein the scrolling continues during the display. For example, while the selection is playing, additional scrolling of the set of video content among the scrolling the sets of video content can continue. In one implementation, the selection can be removed from the scrolling queue so that the selection is no longer scrolled after selection.

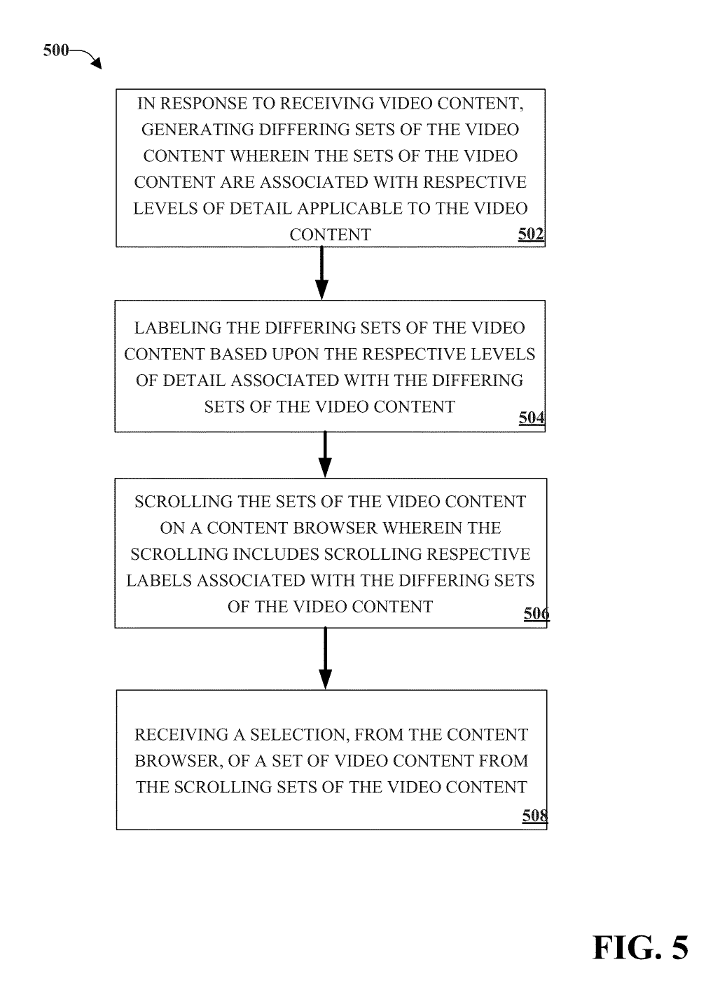

Referring now to FIG. 5, there is illustrated an example flow diagram method 500 for auto annotation of video content for labeling, display and scrolling. At 502, in response to receiving video content, generating, by at least one computing device including at least one processor, differing sets of the video content wherein the sets of the video content are associated with respective levels of detail applicable to the video content.

At 504, the differing sets of video content can be labeled based upon the respective levels of detail associated with the differing sets of the video content. For example, the labels can relate to individuals on video, individuals on audio, camera locations, video scenes, video chapters, random sections of video (with or without a time stamp), a summary of content based on analysis of audio features and/or video features, etc. It can be appreciated that the labels can be uniquely tailored to give a description of the video intuitively understandable by a user of a content browser while still being based on the level of detail.

At 506, the sets of the video content can be scrolled on a content browser wherein the scrolling includes scrolling respective labels associated with the differing sets of video content. For example, where the differing sets of the video content relate to a movie, differing sets of the video content can be scenes related to specific actors or actresses within the scene. The level of detail can described that one set of video is all scenes with a certain actor; a second set of video is all scenes with a different actor; etc. Labels can be established that intuitively present to a user that the set of videos contain scenes relating to an actor. The labels can then be attached or associated with the scrolling video content, and be available for recognition by an individual viewing the scrolling sets of video content. This is just one example of a type of labeling system that can be established, and it can be appreciated that other intuitive labeling methods can be used for differing types of video content.

At 508, a selection can be received, from the content browser, of a set of video content from the scrolling sets of video content.

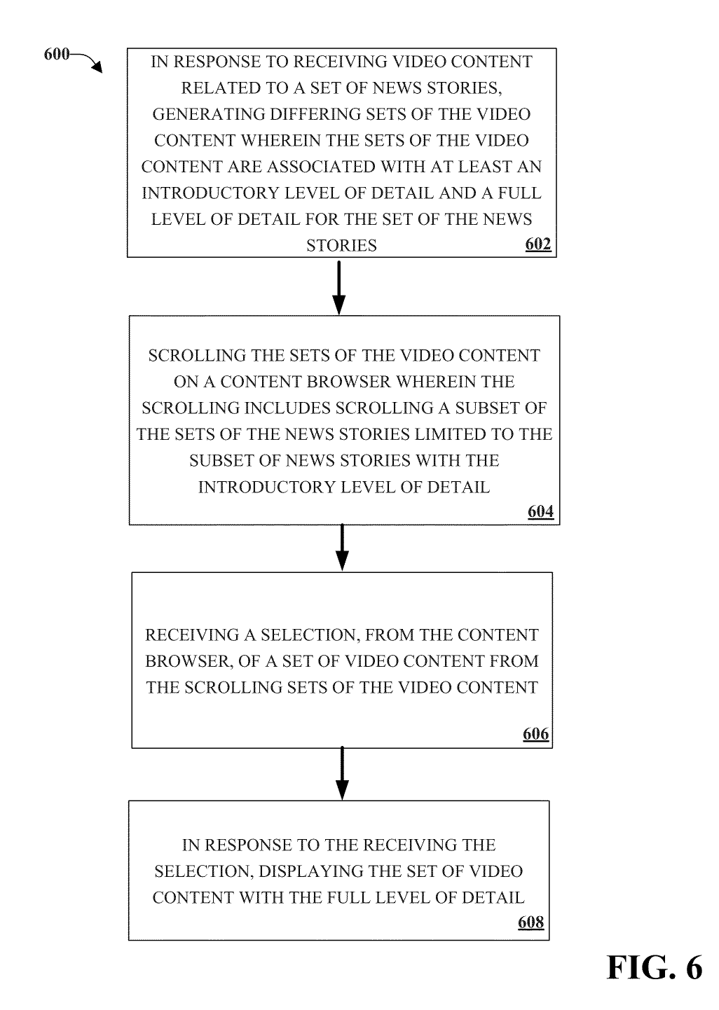

Referring now to FIG. 6, there is illustrated an example flow diagram method 600 for auto annotation of video content for display and scrolling associated with news stories. At 602, in response to receiving video content related to a set of news stories, generating differing sets of the video content wherein the sets of the video content are associated with at least an introductory level of detail and a full level of detail for the set of the news stories. For example, for every individual story, an introductory level video and a full detail level video can be generated. It can be appreciated that other levels of detail can also be generated, for example, a level of detail that includes more video content than the introductory level, but less video content that the full detail level.

At 604, scrolling the sets of the video content on a content browser wherein the scrolling includes scrolling a subset of the sets of the news stories limited to the subset of news stories with the introductory level of detail. For example, the scrolling video content would be the introductory level content for each news story in the set of news stories. Strictly the introductory level content would scroll.

At 606, a selection can be received, from the content browser, of a set of video content among the scrolling sets of video content. At 608, in response to the selection, the full detail level video associated with the introductory level video content can be displayed. In one embodiment, during display of the full detail level video content, introductory level video content of other news stories can continue scrolling.

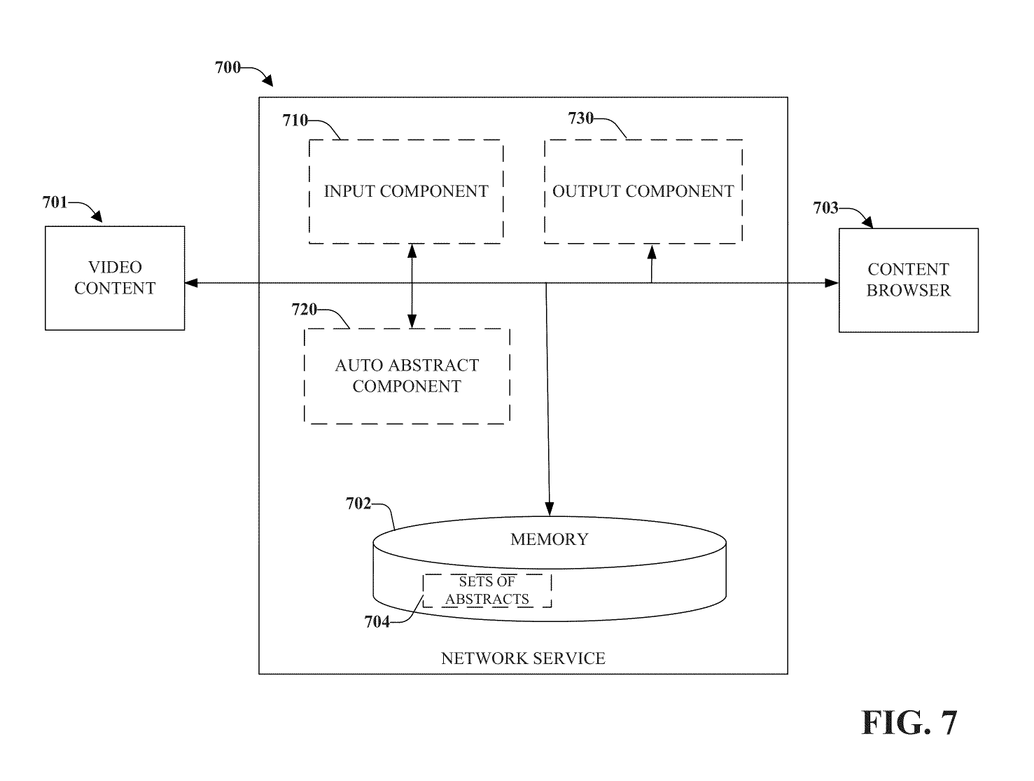

Referring now to FIG. 7, there is illustrated an example network service 700. An input component 710 can receive video content 701. An auto abstract component 720 can generate a set of abstracts 704 of the video content in response to reception of the video content. It can be appreciated that the sets of abstracts 704 can be generated based on random scenes of the video content, predefined chapters, video analysis, audio analysis, etc. Sets of abstracts 704 can be stored within memory 702. An output component 730 can send a first set of the sets of the abstracts to a content browser 703. Content browser 703 can be an internet browser, a software application, hardware, etc., that allows video to be displayed on a video device including televisions, computers, tablets, e-readers, smart phones, etc.

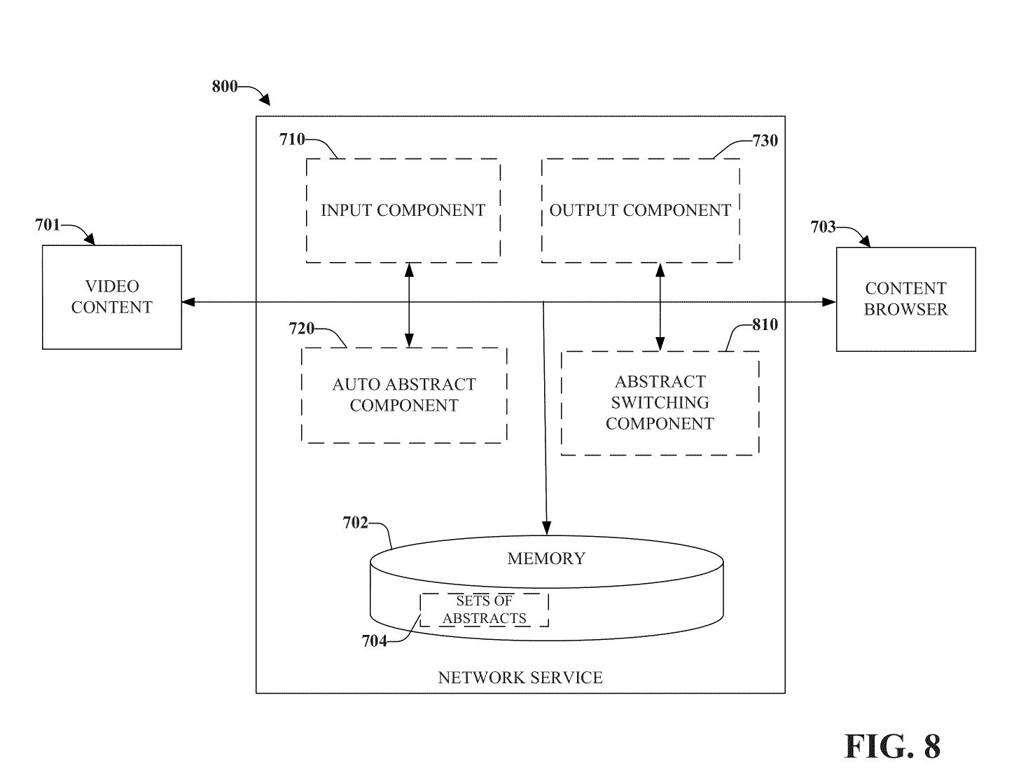

Referring now to FIG. 8, there is illustrated an example network service 800 including an abstract switching component 810 that can direct the output component to send a second set of the sets of abstracts, different from the first set, based on receiving from the content browser 703 a notice of completion or a notice to switch abstracts. For example, receiving a notice of completion can indicate to abstract switching component that a viewer on the content browser 703 has completed watching an abstract. In another example, receiving a notice to switch abstracts from content browser 703 can indicate that a user of the content browser 703 desires to watch a different abstract prior to completion of viewing the currently displaying abstract.

In one embodiment, abstract switching component can further dynamically determine an access time associated with a viewed set of abstracts. For example, if the content browser 703 has displayed forty-three seconds of content in a video abstract before receiving a notice to switch abstracts, that forty-three seconds can be determined as an access time. In another example, upon receiving a notice of completion, abstract switching component can determine the length of the completed abstract as an access time.

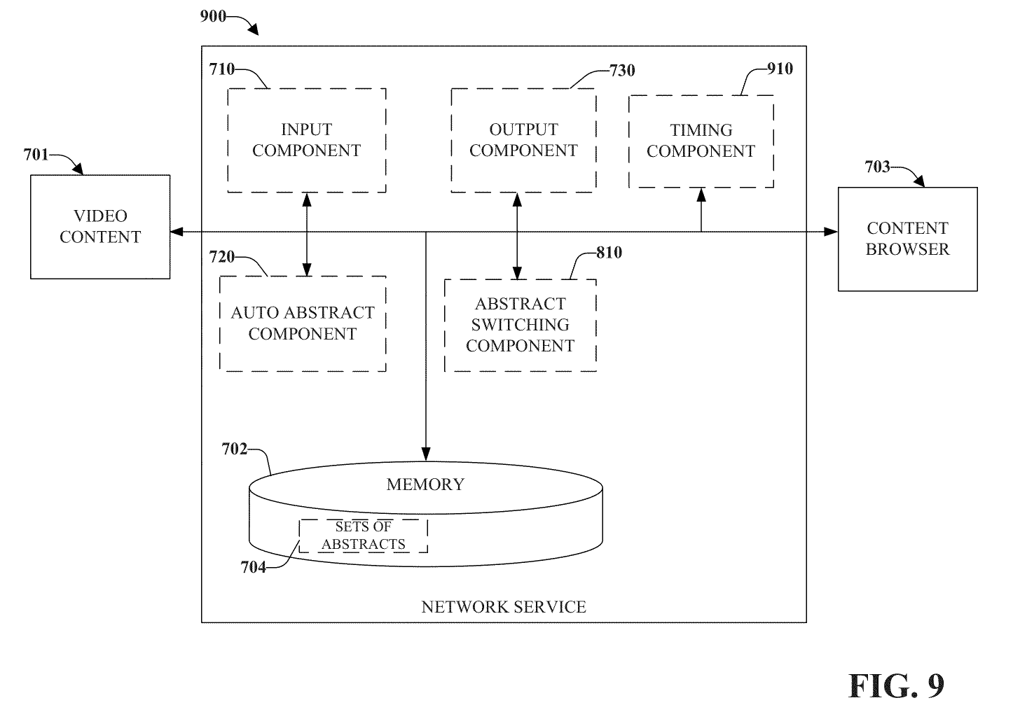

Referring now to FIG. 9, there is illustrated an example network service 900 including a timing component 910 that can determine an aggregated viewing timer as a function of a set of access times from the abstract switching component 810. For example, if abstract switching component 810 has noted three access times to three abstracts, timing component 910 can aggregate the three to arrive at a total viewing time. In one embodiment, output component 730 can dynamically send the aggregated viewing timer for display on the content browser.

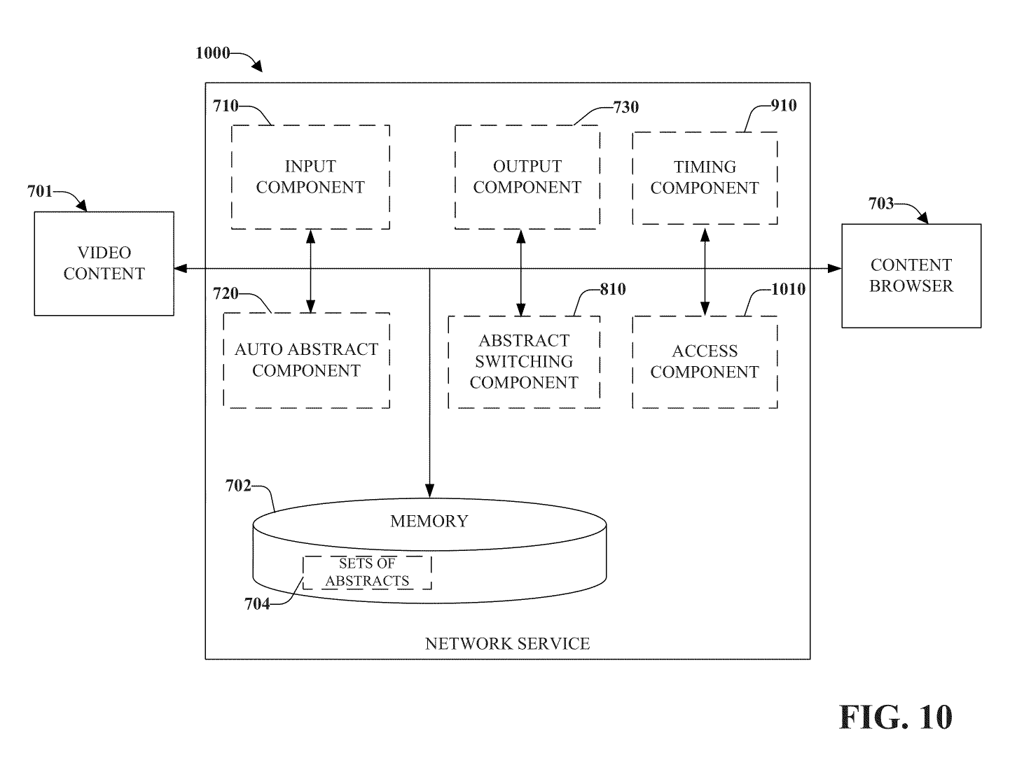

Referring now to FIG. 10, there is illustrated an example network service 1000 including an access component 1010 that can limit access to sets of abstracts based on the aggregated viewing timer associated with content browser 703. For example, access to the set of abstracts related to content can be limited to a percentage of the total length of the content, or a certain time window. If a time limit of three minutes is set up, then a user may view abstracts related to the content for an aggregate total of three minutes, after which, they can, for example, purchase the content in full.

In one embodiment, access component 1010, upon limiting access, can further send a link for display in the content browser for a user of the content browser to purchase content associated with the sets of abstracts.

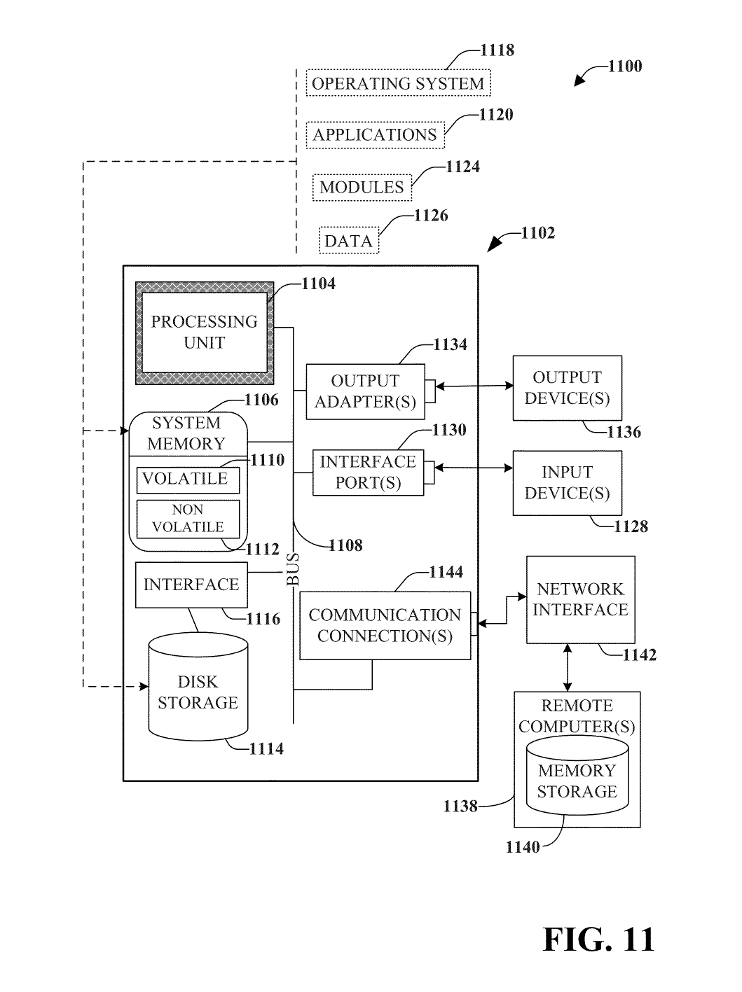

With reference to FIG. 11, a suitable environment 1100 for implementing various aspects of the claimed subject matter includes a computer 1102. The computer 1102 includes a processing unit 1104, a system memory 1106, and a system bus 1108. The system bus 1108 couples system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1106 includes volatile memory 1110 and non-volatile memory 1112. The basic input/output system (BIOS), containing the basic routines to transfer information between elements within the computer 1102, such as during start-up, is stored in non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), or flash memory. Volatile memory 1110 includes random access memory (RAM), which acts as external cache memory. According to present aspects, the volatile memory may store the write operation retry logic (not shown in FIG. 11) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1102 may also include removable/non-removable, volatile/non-volatile computer storage media. FIG. 11 illustrates, for example, a disk storage 1114. Disk storage 1114 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1114 to the system bus 1108, a removable or non-removable interface is typically used, such as interface 1116.

It is to be appreciated that FIG. 11 describes software that acts as an intermediary between users and the basic computer resources described in the suitable operating environment 1100. Such software includes an operating system 1118. Operating system 1118, which can be stored on disk storage 1114, acts to control and allocate resources of the computer system 1102. Applications 1120 take advantage of the management of resources by operating system 1118 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems.

A user enters commands or information into the computer 1102 through input device(s) 1128. Input devices 1128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s) 1128. Thus, for example, a USB port may be used to provide input to computer 1102, and to output information from computer 1102 to an output device 1136. Output adapter 1134 is provided to illustrate that there are some output devices 1136 like monitors, speakers, and printers, among other output devices 1136, which require special adapters. The output adapters 1134 include, by way of illustration and not limitation, video and sound cards that provide a means of connection between the output device 1136 and the system bus 1108. It should be noted that other devices and/or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for exemplary purposes only, internal and external technologies such as, modems including regular telephone grade modems, cable modems and DSL modems, ISDN adapters, and wired and wireless Ethernet cards, hubs, and routers.

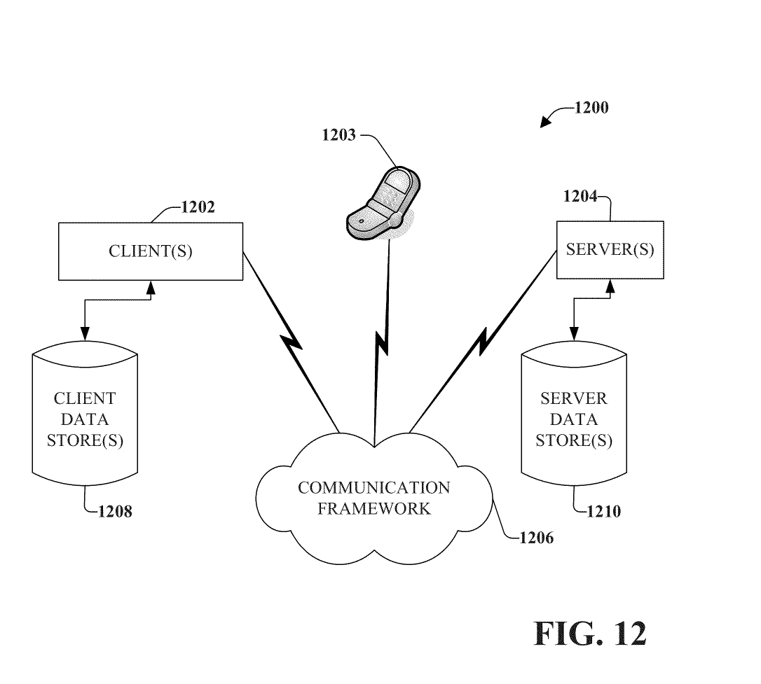

Referring now to FIG. 12, there is illustrated a schematic block diagram of a computing environment 1200 in accordance with the subject specification. The system 1200 includes one or more client(s) 1202, which can include an application or a system that accesses a service on the server 1204. The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware or hardware in combination with software (e.g., threads, processes, computing devices). The servers 1204 can house threads to perform, for example, identifying morphological features, extracting meaning, auto annotating content, etc. One possible communication between a client 1202 and a server 1204 can be in the form of a data packet adapted to be transmitted between two or more computer processes where the data packet contains, for example, a certificate, a notice of completion, a notice to switch abstracts, etc. The data packet can include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A method, comprising:
in response to receiving video content, generating, by at least one computing device including at least one processor, differing sets of the video content wherein the sets of the video content are associated with respective levels of detail applicable to the video content;
scrolling the sets of the video content on a content browser; and
receiving a selection, from the content browser, of a set of video content from the scrolling sets of the video content.

2. The method of claim 1, further comprising:
in response to the receiving the selection, displaying the selection, wherein the scrolling continues during the displaying.

3. The method of claim 2, further comprising:
in further response to the receiving the selection, removing the selected set of the video content from the scrolling sets of the video content.

4. The method of claim 1, further comprising:
labeling the differing sets of the video content based upon the respective levels of detail associated with the differing sets of the video content.

5. The method of claim 4, wherein the scrolling includes scrolling respective labels associated with the differing sets of the video content.

6. The method of claim 1, wherein the video content includes a set of news stories.

7. The method of claim 6, wherein the generating includes generating at least an introductory level of detail and a full level of detail for the set of the news stories.

8. The method of claim 7, wherein the scrolling includes scrolling a subset of the sets of the news stories limited to the subset of the news stories with the introductory level of detail.

9. The method of claim 7, further comprising:
in response to the receiving the selection, displaying the set of the video content with the full level of detail.

10. The method of claim 1, wherein the video content includes a set of trailers for the video content.

11. The method of claim 10, wherein a plurality of the trailers of the set of the trailers relate to a same underlying video content.

12. The method of claim 10, wherein a plurality of the trailers of the set of the trailers relate to differing video content.

13. A network service, comprising:
a memory that stores computer executable components; and
a processor that facilitates execution of computer executable components stored within the memory, the computer executable components, comprising:
an input component that receives video content;
an auto abstract component that generates sets of abstracts of the video content in response to reception of the video content; and
an output component that sends a first set of the sets of the abstracts to a content browser.

14. The network service of claim 13, the computer executable components further comprising:
an abstract switching component that directs the output component to send a second set of the sets of the abstracts, different from the first set, based on receiving from the content browser a notice of completion or a notice to switch abstracts.

15. The network service of claim 14, wherein the abstract switching component determines an access time associated with a viewed set of the sets of the abstracts.

16. The network service of claim 15, the computer executable components further comprising:
a timing component that determines an aggregated viewing timer as a function of a set of access times from the abstract switching component.

17. The network service of claim 16, wherein the output component outputs the aggregated viewing timer for display by the content browser.

18. The network service of claim 16, the computer executable components further comprising:
an access component that limits access to a subset of the sets of the abstracts based on the aggregated viewing timer associated with the content browser.

19. The network service of claim 18, wherein the access component, in response to access being limited, generates a link for display in the content browser that enables purchase of content associated with the sets of the abstracts.

20. A computer-readable storage medium comprising computer-executable instructions that, in response to execution, cause a computing system including a processor to perform operations, comprising:
in response to receiving video content, generating differing sets of the video content wherein a set of the sets of the video content is associated with a level of detail different from another level of detail associated with at least one other set of the sets of the video content;
receiving first input that scrolls the sets of the video content on a content browser;
receiving second input that selects the set of the video content among the scrolled sets of the video content; and
in response to the receiving the second input, displaying the set of the video content without interruption of the scrolling.
